(19) United States
(12) Patent Application Publication
(10) Pub. No.: US 2009/0160337 A1
(43) Pub. Date: Jun. 25, 2009

(54) Film for Improving Contrast and Plasma Display Panel and Display Device Including the Same

(76) Inventors: Sang-Hyun Park, Daejeon (KR); Yeon-Keun Lee, Daejeon (KR); Jung-Doo Kim, Daejeon (KR); Jong-Hun Kim, Daejeon (KR); Hae-Sung Cho, Daejeon (KR)

Correspondence Address: MCKENNA LONG & ALDRIDGE LLP, 1900 K STREET, NW, WASHINGTON, DC, 20006, US

(21) Appl. No.: 12/224,550

(22) PCT Filed: Aug. 17, 2007
(86) PCT No.: PCT/KR2007/003937

§ 371 Date: Aug. 29, 2008

(30) Foreign Application Priority Data
Aug. 17, 2006 (KR) 10-2006-0077567

(51) Int. Cl. H01J 17/49; B32B 3/10; B32B 3/26

(52) U.S. Cl. 313/587; 428/54; 428/56

(57) ABSTRACT

There is provided a film for improving contrast, the film including a plurality of stripes each having a section in the shape of one of a trapezoid, a triangle, with a decreasing width from a surface of the film to an inner portion of the film, a rectangle, and a parallelogram, having a constant width from the surface of the film to the inner portion of the film. In a cross-sectional view cut along a thickness direction of the film, a line connecting an inner edge of an inner portion of one stripe with an inner edge of an outer portion of another adjacent stripe forms a shielding angle of 15 to 50° with a normal line perpendicular to a surface of the film.

This application is an application based on International Patent Application No. PCT/KR2007/003937 filed Aug. 17, 2007, which claims the benefit of Korean Application No. 10-2006-0077567 filed Aug. 17, 2006, which are hereby incorporated by reference for all purposes as if fully set forth herein.

### TECHNICAL FIELD

The present invention relates to a film for improving contrast, and a plasma display panel (PDP) filter and a display device including the same, and more particularly, to a film for improving contrast, the film blocking light incident from an external light source as much as possible, thereby minimizing degradation of contrast and preventing moire when mounted to a display device, and to a PDP filter and a PDP display device including the same.

### BACKGROUND ART

In general, a plasma display panel (PDP) display device realizes a picture by exciting the fluorescent material of desired pixels by ultraviolet radiation generated by gas discharge generated between electrodes.

Due to these characteristics of the PDP device, various types of electromagnetic waves and near ultraviolet rays are emitted, which are not only harmful to human body but also may be a cause of malfunction of surrounding electronic devices. Therefore, a filter is attached to a surface of the PDP device to shield the electronic waves and ultraviolet rays. The filter includes one of an electromagnetic wave shielding net and a near ultraviolet ray shielding film to absorb and shield the electromagnetic waves of a near ultraviolet ray region.

Since the light emitted from a PDP should reach the viewer via the filter, the PDP filter should be transparent in general.

However, during the day or in an environment with bright light, i.e., under a bright room condition, not only the light is emitted out of the PDP display device via the filter but also external light from the outside may enter the display device via the PDP filter. The external light entering from the outside may be reflected at the PDP panel and overlapped with the light emitted from the PDP panel to reach the viewer. Hereinafter, the external light from the outside, which is reflected at the panel and emitted back to the outside, is called reflected light.

As described above, when the light enters the display device via the transparent PDP filter, is overlapped with the light emitted from the PDP panel, and is emitted to the outside, a contrast ratio of a picture is significantly degraded. That is, the contrast ratio represents a ratio of a brightness of the light emitted from a brightest pixel to a brightness of the light emitted from a darkest pixel, and has the following relationship when only the light emitted from the PDP panel (under a perfect dark room condition) is considered.

$$contrast ratio ( dark room condition ) = \begin{matrix}brightness of white light \\ brightness of black light\end{matrix} \qquad Equation 1$$

However, as described above, when white light and black light each including a certain portion of the reflected light are emitted together under a bright room condition, the equation is different. That is, since the white light and the black light includes the same portion of reflected light, the brightness of the pixels expressing the white light and the black light increases in accordance with the brightness of the reflected light, which may be expressed by the following Equation 2.

$$contrast ratio ( bright room condition ) = \frac{\begin{matrix}brightness of white light + \\ brightness of reflected light\end{matrix}}{\begin{matrix}brightness of white light + \\ brightness of reflected light\end{matrix}} \qquad Equation 2$$

Since the brightness of white light is greater than the brightness of black light, the contrast ratio according to Equation 1 generally has a value greater than 1. In this case, when the brightness of the reflected light is added to the numerator and the denominator, respectively, the contrast ratio decreases. Therefore, for the same display device, a dark room contrast ratio is significantly different from a bright room contrast ratio.

The contrast ratio represents how easily the pixels are distinguished, and a higher contrast ratio indicates a clearer picture. Therefore, when other conditions are fixed, it is necessary to maintain a high contrast ratio as possible. In particular, since the bright room contrast ratio is lower than the dark room contrast ratio, it is necessary to increase the bright room contrast ratio.

Conventionally, there has been proposed a technology of using a color-correcting film to increase the contrast ratio. That is, the color-correcting film increases the contrast ratio of Equation 1 by decreasing the brightnesses of both the white light and the black light emitted from the display device. However, when the color-correcting film is used, the brightness of the light emitted from the PDP also decreases, which disadvantageously lowers the luminance of the picture.

### DISCLOSURE OF INVENTION

### Technical Problem

An aspect of the present invention provides a film for improving a contrast ratio of a picture without decreasing a brightness of light emitted from a plasma display panel (PDP), and a PDP filter and a display device including the same.

An aspect of the invention also provides a PDP filter and a display device capable of preventing moire by employing the above-described film to increase a contrast ratio.

An aspect of the invention also provides a PDP filter and a display device capable of preventing a ghost image by employing the above-described film.

### Technical Solution

According to an aspect of the invention, there is provided a film for improving contrast, the film including a plurality of stripes each having a section in the shape of one of a trapezoid, a triangle, with a decreasing width from a surface of the film to an inner portion of the film, a rectangle, and a parallelogram, having a constant width from the surface of the film to the inner portion of the film, wherein, in a cross-sectional view cut along a thickness direction of the film, a line connecting an inner edge of an inner portion of one stripe with an inner edge of an outer portion of another adjacent stripe forms a shielding angle of 15 to 50° with a normal line perpendicular to a surface of the film.

In this case, the shielding angle may be 20 to 35°.

The film may be formed on a supporting body, and the supporting body may be formed of a transparent plastic film selected from a group consisting of a polyester resin film, an acrylic resin film, a cellulose resin film, a polyethylene resin film, a polypropylene resin film, a polyolefin resin film, a polyvinylchloride resin film, a polycarbonate resin film, a phenolic resin film, and a urethane resin film, and particularly, a polyester film.

In addition, the film may include at least one transparent film layer.

In detail, the stripe may have a pitch, which is a distance between a center of a stripe to a center of another adjacent stripe, of 50 to 120□, and a depth of 70 to 200□.

In this case, the stripe may be formed of at least one selected from a group consisting of a black ink, a black dye, a black pigment and an inorganic material.

In addition, an area ratio of the stripes to a surface area of the film may be 50% or less.

In addition, the stripes may be formed in a material formed of at least one ultraviolet curable resin selected from a group consisting of urethane acrylate, epoxy acrylate, ester acrylate, ether acrylate and radical generating monomer.

According to another aspect of the invention, there is provided a filter for improving contrast, which is a PDP filter on which the film for improving contrast according to any one of claims 1 to 10 is stacked, the filter including at least one of a transparent substrate, an anti-reflective layer and an electromagnetic wave shielding layer, wherein the stripes of the film for improving contrast are disposed at an angle of 0 to 15° with respect to a horizontal side of the filter, and more particularly, at an angle of 0 to 5° with respect to the horizontal side of the filter.

In this case, horizontal lines of an electromagnetic wave shielding net included in the electromagnetic wave shielding layer may be formed at an angle of 35 to 55° with respect to the horizontal side of the filter.

In addition, a pitch, which is a distance between center lines of two adjacent ones of horizontal and vertical lines of the electromagnetic shielding net, may be 100 to 500□.

In addition, each of the horizontal lines and vertical lines of the electromagnetic wave shielding net may have a thickness of 5 to 35□.

In this case, the electromagnetic wave shielding net may be formed of a material selected from a group consisting of Cu, Ag, Ni, Al, Cr, Fe and Ti.

In addition, the film for improving contrast may be directly attached to the PDP filter so as to prevent ghost images.

According to another aspect of the invention, there is provided a PDP device comprising a PDP panel and the above-described filter attached to the PDP panel, wherein the stripes of the film for improving contrast included in the filter for improving contrast are formed at 0 to 15° with respect to horizontal lines forming a pixel region of the PDP panel, and horizontal lines of the electromagnetic wave shielding net included in the electromagnetic wave shielding layer are disposed to form an angle of 35 to 55° with respect to the horizontal lines forming the pixel region of the PDP panel.

In this case, a pitch, which is a distance between center lines of two adjacent ones of the horizontal lines and vertical lines of the electromagnetic shielding net, may be 100 to 500□.

In addition, each of the lines of the electromagnetic wave shielding net may have a thickness of 5 to 35□.

In this case, the electromagnetic wave shielding net may be formed of a material selected from a group consisting of Cu, Ag, Ni, Al, Cr, Fe and Ti.

In addition, the film for improving contrast may be directly attached to the PDP filter.

### Advantageous Effects

The present invention provides a film for improving contrast, capable of improving a contrast ratio without degrading a brightness of the light emitted from a PDP, and a PDP filter and a display device including the same. In addition, the PDP filter and the display device according to the present invention provide a high quality picture by preventing more.

Furthermore, the PDP filter and the display device according to the present invention are capable of preventing a ghost image, thereby providing a clearer picture.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a perspective view illustrating a film for improving contrast according to an exemplary embodiment of the present invention;

FIG. 2 is a schematic cross-sectional view illustrating the film for improving contrast according to an exemplary embodiment of the present invention in order to explain the terms such as a shielding angle and a pitch and a depth of stripes of the film;

FIG. 3 is a cross-sectional view illustrating the film for improving contrast according to an exemplary embodiment of the present invention in order to demonstrate the principle by which light is shielded by the stripe shielding pattern formed in the film;

FIG. 4 is a view illustrating the reason for formation of a ghost image, in which (a) illustrates a case in which the film for improving contrast is directly attached to a PDP filter and the ghost image is not formed and (b) illustrates a case in which the film for improving contrast is attached to a separate component and the ghost image is formed;

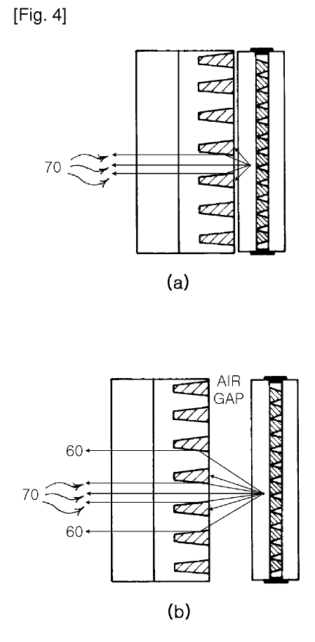

FIG. 5(a) is a picture without the ghost image, and FIG. 5(b) is a picture with the ghost image;

FIG. 6 is a conceptual view illustrating the terms such as a pitch, a width and an angle in a PDP pixel region;

FIG. 7 is a view illustrating dimensions of the film for improving contrast for inventive samples 1 and 2 according to an exemplary embodiment of the present invention;

FIG. 8(a) and FIG. 8(b) are schematic views illustrating stacked forms of PDP filters of inventive sample and comparative sample, respectively;

FIG. 9 is a graph illustrating a relationship between a shielding angle and a contrast ratio; and

FIG. 10 is a graph illustrating a relationship between a shielding angle and a viewable angle.

### BEST MODE FOR CARRYING OUT THE INVENTION

Exemplary embodiments of the present invention will now be described in detail with reference to the accompanying drawings.

A film according to the present invention decreases a brightness of the reflected light in Equation 2 by blocking external light entering from the outside, instead of by decreasing brightnesses of both of black light and white light to improve a contrast ratio, i.e., decreasing a brightness of an entire picture to improve the contrast ratio.

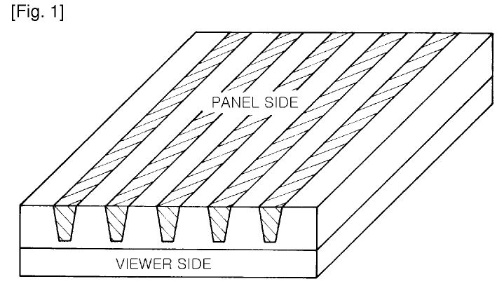

That is, as shown in FIG. 1, the film according to the present invention includes a plurality of stripes. Each of the stripes is formed in a certain depth from a surface of the film, in a thickness direction of the film. In particular, each of the stripes may have a smaller width in a surface portion of the film than in an inner portion of the film.

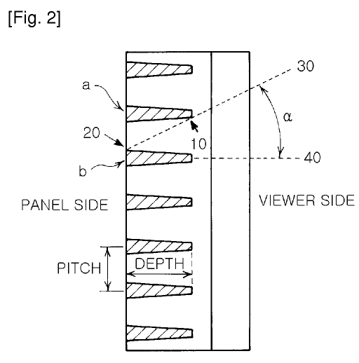

Therefore, examining a cross-section of the film shown in FIG. 2, each of the stripes may have a section in the shape of one of a trapezoid with a larger width in a surface portion of the film than in an inner portion of the film, a triangle to an extreme, and a rectangle or a parallogram with a constant width.

The external light entering from the outside is blocked by the above-described stripes as much as possible while the light emitted out of the panel can reach the observer without being blocked. The reason for this in detail is as follows.

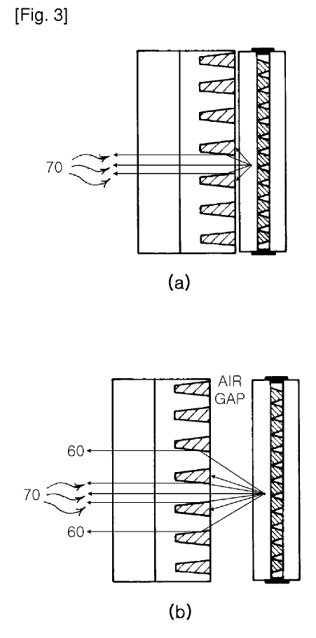

As shown in FIG. 3, when the film having the stripes is formed at an outer side of a PDP display device, the stripes function as a blocking wall for blocking light. That is, the light incident into the panel via a PDP filter, at a certain angle or greater, is absorbed and blocked by the stripes. Therefore, in order for the external light to reach the panel and be reflected, it has to be incident almost perpendicularly to a surface of the film. Thus, only a very small portion of the external light may be included in the portion of light actually emitted from the display device.

In addition, having a shape narrowing toward an outer side of the display device (in a thickness direction of the film) when viewed from a side of the PDP panel, the stripes prevent the light emitted out of the panel from being blocked in its path as much as possible, thereby maintaining a sufficient brightness of the emitted light.

As a result, the brightness of the reflected light in Equation 2 may be minimized, and as a result, a contrast ratio is maximized while the brightness of the light emitted from the panel is not decreased.

The wider side of the stripe may be arranged toward the panel as described above, but the present invention is not limited thereto and either side of the film may be arranged toward the panel or the viewer.

The stripes need to be formed in appropriate dimensions to yield the above-described effect. According to the results of the research conducted by the inventors of the present invention, the stripes may be formed in such a shape that a shielding angle shown in FIG. 2 may be formed in predetermined degrees or smaller. That is, the shielding angle shown in FIG. 2 refers to an angle formed by a line 30 connecting an inner edge 10 of one stripe with an inner edge 20 at the surface side of the film of another adjacent stripe and a normal line 40 perpendicular to the surface of the film. With a larger shielding angle, a greater portion of light may be incident into the panel without being blocked by the stripes. Therefore, a narrower shielding angle is advantageous in terms of the contrast ratio. However, too small a shielding angle decreases a vertical viewable angle too much, causing problems with visibility. Therefore, the shielding angle may be 15 to 50° and particularly 20 to 35°.

In addition, the stripes may have a pitch, designating a distance between centers of two adjacent stripes, of 50 to 120□, and each stripe may have a depth of 70 to 200□. When the pitch is too large or when the depth is too large, the film has too large a thickness and the stripes are visually observable, which is not desirable. When the pitch is too small or when the depth is too small, great precision is required in forming the stripes, resulting in a difficult process.

In addition, an area ratio occupied by the stripes to the film surface may be 50% or less. When the area ratio of the stripes exceeds 50%, the light emitted from the display device is excessively blocked, decreasing the brightness. In addition, there is no need to fix a lower limit of the area ratio of the stripes because it is more advantageous that the stripes occupy a small area as possible as long as the shielding effect is sufficient. However, too small an area ratio of the stripes requires forming micro stripes. Considering this, it is general that the area ratio of the stripes is determined to be 5% or more.

When the stripes are formed in the dimensions as described above, the external light incident into the plasma display panel is minimized, and the light is emitted out of the panel without being blocked, thereby improving the contrast ratio as much as possible to a degree that does not decrease the brightness of the display device.

Therefore, the film for improving contrast according to the present invention includes a plurality of stripes having a section in the shape of one of a trapezoid, a triangle, with a decreasing width from a surface of the film to an inner portion of the film, a rectangle, and a parallelogram, with a constant width from the surface of the film to the inner portion of the film. Also, in a cross-sectional view cut along a thickness direction of the film for improving contrast, a line connecting an inner edge of an inner portion of one stripe with an inner edge of an outer portion of another adjacent stripe may form an angle (a shielding angle) of 15 to 50° and particularly, 20 to 35° with a normal line perpendicular to the surface of the film.

In order to ensure a maximal light-shielding effect of the film for improving contrast while facilitating emission of the light out of the panel, the stripes may be formed in a material formed of a UV-curable transparent resin, and particularly, at least one light curable resin selected from a group consisting of urethane acrylate, epoxy acrylate, ester acrylate, ether acrylate and radical generating monomer. The material may be by itself or may be formed on a supporting body, which may be a transparent plastic film selected from a group consisting of a polyester resin film, an acrylic resin film, a cellulose resin film, a polyethylene resin film, a polypropylene resin film, a polyolefin resin film, a polyvinylchloride resin film, a polycarbonate resin film, a phenolic resin film, and a urethane resin film, and more particularly, a polyester film material. In addition, the film for improving contrast may include one or more transparent film layers if necessary.

The stripes of the film for improving contrast may be formed by fabricating a mold using a bite, forming the shape of the stripes with UV-curable resin, and then filling the shape of mold with a black resin. The material of the stripes may have a light absorption ratio of 10/mm and more and particularly, 40/mm or more according equation 3 described hereinafter. When the material of the stripes has a light absorption ratio smaller than the above described value, it disadvantageously has an insufficient blocking effect of light. The material of the stripes having such a blocking effect may be formed of at least one selected from a black ink, a black dye, a black pigment and an inorganic material.

$$α = - \frac{ln ( I / {I}_{o} )}{L} \qquad Equation 3$$

In this case, Iₒ designates an intensity of light (in particular, visible rays) before passing through the material of the stripes, I designates an intensity of light after passing through the material of the stripes, and L designates a thickness of the material of the stripes.

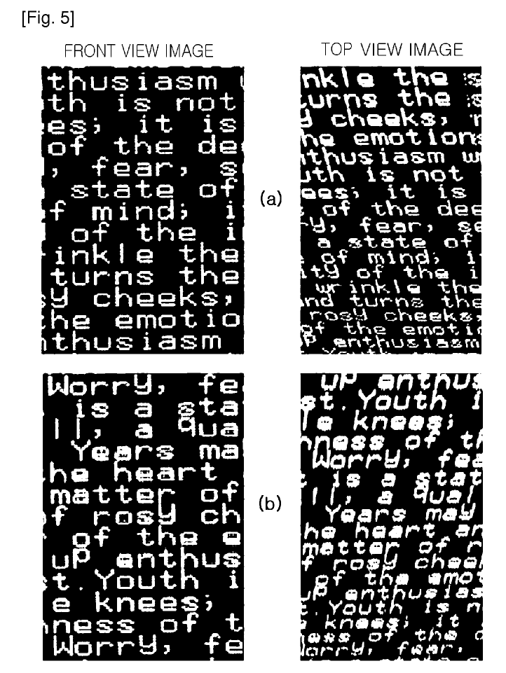

The film for improving contrast may be attached to a generally-used PDP filter for use. That is, conventionally, the film for improving contrast is attached on a surface of a transparent material such as a glass substrate, which is separately mounted to a PDP display device with an air gap in between. In this case, however, a so-called ghost image may be formed. When a large gap such as an air gap exists between a surface of the PDP display device and the film for improving contrast, the light emitted from a surface of the display device passes not only between the stripes into which the light is incident, as denoted by reference numeral 70, but also passes between other adjacent stripes, as denoted by reference numeral 60. This results in emission of light not only in an area intended for expression between the stripes into which the light is incident but also in areas between other stripes, thereby causing a smudging or spreading phenomenon of an image as shown in FIG. 5(b), which is referred to as the ghost image.

Such a phenomenon is more visible when an interval between a pixel region of the display device and the stripes is larger. Therefore, the film for improving contrast may be provided by being directly attached to the PDP filter. In this case, the type of the PDP filter including the film for improving contrast is not specifically limited. That is, a typical PDP filter includes a transparent substrate, an anti-reflective layer and an electromagnetic shielding layer PDP stacked in any order. The PDP filter including the film for improving contrast according to the present invention includes a transparent substrate, an anti-reflective layer, an electromagnetic wave shielding layer, and other necessary functional layers stacked in any order.

The film for improving contrast is effective for improving the contrast ratio of a display device by blocking the external light. However, since the film for improving contrast has the stripes formed in a surface thereof, it should be disposed at an appropriate angle. Otherwise, the film may have interference with a mesh of an electromagnetic wave shielding film separately formed or included in the PDP filter, or with a pixel pattern of the PDP panel, thereby potentially causing moire.

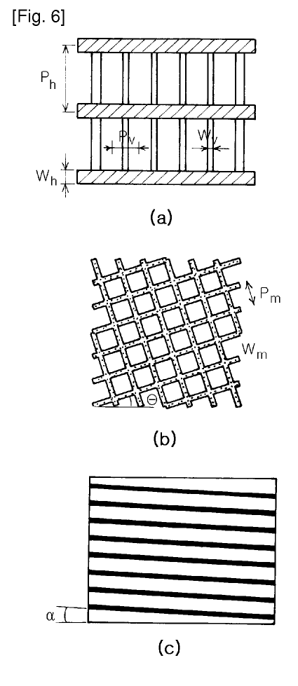

The inventors of the present invention found that in order to prevent moire, the stripes of the film for improving contrast may be disposed at an angle (denoted by α in FIG. 6) of 0 to 15° and particularly, 0 to 5° with respect to a horizontal side of the filter as shown in FIG. 6(c), given that the PDP display device has a pixel pattern in which horizontal lines are parallel to the horizontal side of the filter and the horizontal lines and vertical lines are substantially perpendicular to each other. In addition, the mesh of the electromagnetic wave shielding film may be disposed at an angle (denoted by θ in FIG. 6) of 35 to 55° with respect to the horizontal side of the filter as shown in FIG. 6(b) in order to prevent moire with one of the pixel pattern and the film for improving contrast.

At this time, in order to further suppress moire, for example, a pixel region of the PDP display device may have a horizontal pitch (denoted by pᵥ in FIG. 6) of about 300□ and a vertical pitch (denoted by pₕ in FIG. 6) of about 670□. In this case, a pitch designates a distance from a center of one of the horizontal lines (or the vertical lines) to a center of another one of the horizontal lines (or the vertical lines) in the mesh. In addition, in the PDP display device with such pitches, the horizontal lines and the vertical lines may have thicknesses (denoted by wᵥ and wₕ in FIG. 6) of 55□ and 270□, respectively.

In addition, the electromagnetic wave shielding net may also have a pitch (denoted by pₘ in FIG. 6) of 100 to 500□, a thickness (denoted by wₘ in FIG. 6) of 5 to 35□, and the shielding net may be formed of a material having good electric conductivity, such as Cu, Ag, Ni, Al, Cr, Fe and Ti.

Therefore, the PDP filter according to the present invention may have the film for improving contrast stacked thereon and include at least one of a transparent substrate, an anti-reflective layer and an electromagnetic wave shielding layer. Also, the stripes of the film for improving contrast may be disposed at an angle (denoted by in FIG. 6) of 0 to 15 with respect to the horizontal side of the filter.

The PDP display device according to the present invention includes the film for improving contrast or the PDP filter according to the present invention, in which the film for improving contrast may be disposed at an angle (denoted by in FIG. 6) of 0 to 15° with respect to the horizontal lines of the pixel.

More particularly, the film for improving contrast may be disposed at an angle of 0 to 5 with respect to the horizontal lines of the pixel region in order to prevent moire.

### Mode for the Invention

Effect of Stripes

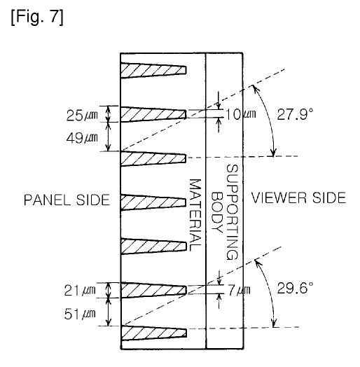

The films for improving contrast for inventive samples 1 and 2 were fabricated under the conditions illustrated in FIG. 7. Each of the films was placed at 2.5 with respect to a horizontal side of the filter and attached directly to a PDP panel and the change in the contrast ratio was observed. In this case, area ratios of the stripes to surfaces of the films were set to be 33.8% and 29.2% for the inventive samples 1 and 2, respectively. The stripes were formed in a urethane light-curable resin, and the stripes were formed of black ink. In addition, the supporting body illustrated in FIG. 7 was formed of a polyester film. The shielding net of the electromagnetic wave shielding layer was disposed at an angle of 41 with respect to the horizontal side of the PDP panel.

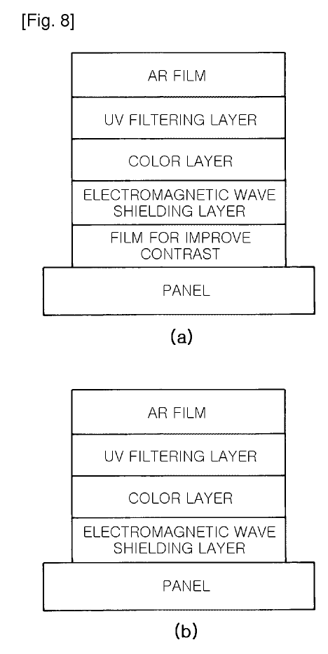

For comparison, a PDP device without the film for improving contrast was manufactured as shown in FIG. 8(b) for comparative sample.

The inventive samples 1 and 2, employing the film for improving contrast, and the comparative sample, without the film for improving contrast, were adjusted to have the substantially same transmittance in layers thereof except the panel, and the results were compared.

For each of the inventive samples 1 and 2 and the comparative sample, a transmittance, a luminance at black level, a luminance at white level and a contrast ratio were measured as shown in Table 1. The luminance and transparency were measured by PR705 spectroradiometer, while varying the luminous intensity at 150 lx, 300 lx and 400 lx.

Table 1

TABLE 1

| | | Inventive | Inventive | Comparative |
|---|---|---|---|---|
| Sample | | sample 1 | Sample 2 | Sample |
| Transmittance (%) | | 42.4 | 44 | 41.8 |
| black level(Cd/ | 150 1× | 1.72 | 2.08 | 3.27 |
| m²) | 300 1× | 3.05 | 3.72 | 6.02 |
| | 400 1× | 3.65 | 4.52 | 7.50 |
| white level(Cd/ | 150 1× | 97.87 | 106 | 103 |
| m²) | 300 1× | 99.03 | 107 | 105.1 |
| | 400 1× | 100.1 | 108.4 | 106.9 |
| contrast ratio | 150 1× | 57.0(81% | 51.0(62% | 31.5 |
| | | increase) | increase) | |
| | 300 1× | 32.5(86% | 28.7(64% | 17.5 |
| | | increase) | increase) | |
| | 400 1× | 27.4(93% | 24.0(69% | 14.2 |
| | | increase) | increase) | |

As confirmed in Table 1, the inventive samples 1 and 2 and the comparative sample exhibited transmittances of 42.4, 44 and 41.8%, respectively, at a similar level. However, the inventive sample 1 exhibited a contrast ratio of 27.4:1 to 57.0:1, and the inventive sample 2 exhibited a contrast ratio of 24.0:1 to 51.0:1, whereas the comparative sample exhibited a contrast ratio of 14.2:1 to 31.5:1, which is much lower than the inventive samples. Therefore, the contrast-improving effect of the film for improving contrast according to the present invention was confirmed.

Effect of Shielding Angle

The same conditions as the inventive sample 1 were applied, and the effects of the shielding angle on the viewable angle and the contrast ratio were observed as the shielding angle was adjusted while varying the stripe pitch. Each of the stripes was a black stripe having a section in the shape of a trapezoid with a depth of 107□, a longer side of 25□, and a shorter side of 10□. In this case, the contrast ratios were examined with varying the stripe pitch for simulating the changes in the bright room contrast ratio while varying the stripe pitch. The simulation was performed by using ASAP simulation program available from BRO.

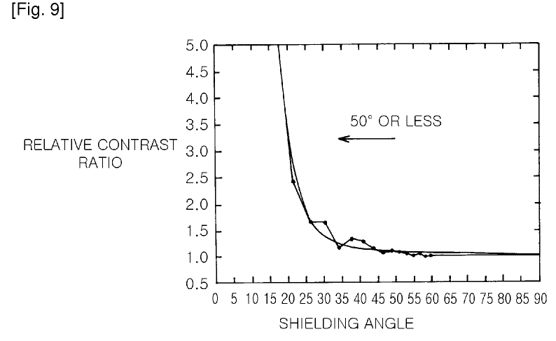

Table 2 shows a relationship between the shielding angle and the contrast ratio, and the results and the trend lines thereof are shown in FIG. 9. The vertical axis of the graph represents a relative contrast ratio, which is a ratio of an increase of a bright room contrast when employing the film for improving contrast, where the contrast ratio without using the film for improving contrast (i.e., mounting a general filter with transmittance of 40%, in which the contrast ratio is 454.3:1) is set as 1.

Table 2

TABLE 2

| | | | | | | Relative |
|---|---|---|---|---|---|---|
| | Shielding | Opening | White | black | Bright room | contrast |
| Pitch(□) | angle(°) | ratio(%) | luminance(cd) | luminance(cd) | contrast(x:1) | ratio |
| 30 | 6.7 | 16.7 | 1386 | 0.06 | 23481.5 | 51.7 |
| 40 | 11.9 | 37.5 | 1991 | 0.29 | 6925.5 | 15.2 |
| 50 | 16.9 | 50.0 | 2170 | 0.95 | 2282.1 | 5.0 |
| 60 | 21.7 | 58.3 | 2232 | 2.19 | 1019.6 | 2.2 |
| 70 | 26.1 | 64.3 | 2302 | 3.30 | 698.3 | 1.5 |
| 80 | 30.3 | 68.8 | 2352 | 3.39 | 693.8 | 1.5 |
| 90 | 34.1 | 72.2 | 2395 | 4.90 | 488.4 | 1.1 |
| 100 | 37.6 | 75.0 | 2417 | 4.34 | 556.6 | 1.2 |
| 110 | 40.8 | 77.3 | 2450 | 4.61 | 531.3 | 1.2 |
| 120 | 43.8 | 79.2 | 2457 | 5.10 | 481.7 | 1.1 |
| 130 | 46.4 | 80.8 | 2494 | 5.58 | 447.2 | 1.0 |
| 140 | 48.9 | 82.1 | 2490 | 5.43 | 458.9 | 1.0 |
| 150 | 51.1 | 83.3 | 2515 | 5.58 | 450.5 | 1.0 |
| 160 | 53.1 | 84.4 | 2545 | 5.78 | 440.4 | 1.0 |
| 170 | 54.9 | 85.3 | 2537 | 5.98 | 424.1 | 0.9 |
| 180 | 56.6 | 86.1 | 2536 | 5.82 | 435.7 | 1.0 |
| 190 | 58.2 | 86.8 | 2532 | 6.15 | 412.0 | 0.9 |
| 200 | 59.6 | 87.5 | 2557 | 6.12 | 418.0 | 0.9 |

In Table 2, the opening ratio represents a ratio of an area through which the light can pass through and is obtained by subtracting the area ratio of the stripes (%) from 100%.

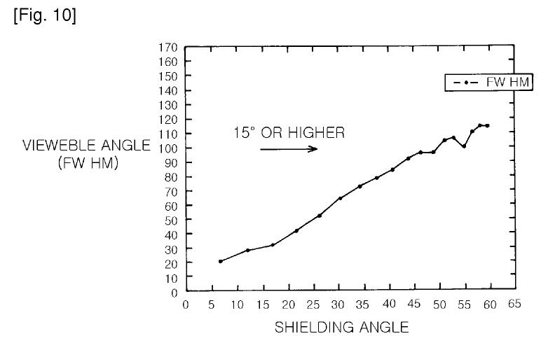

As indicated in FIG. 9 showing the results of Table 2, when the shielding angle was 50° or greater, the contrast ratio was 1.1 times or less, and therefore, the shielding angle of 50° or greater did not contribute to improvement of the contrast ratio. In addition, FIG. 10 shows the relationship between the shielding angle and the viewable angle. As shown in the drawing, when the shielding angle was 15° or less, the viewable angle decreased to 30° (i.e., by 15° in upper and lower directions, respectively). Therefore, the shielding angle may be 15 to 50°. In addition, only when the shielding angle was 35° or less, the contrast ratio was 1.2 times or more, which is significantly higher than the contrast ratio without using the film for improving contrast (FIG. 9). In addition, only when the shielding angle was 20° or more, a relatively wide viewable angle of 40° or more was obtained, and therefore, the shielding angle may be, more particularly, 20 to 35°.

Preventive Effect of Moire

The PDP filter including the film for improving contrast having the advantageous effect as described herein (under the same conditions as inventive sample 1) was attached to a PDP panel to examine the preventive effect of moire. In the panel used in the experiment, the pixel had a horizontal pitch of 300□, a vertical pitch of 670□, a horizontal line thickness of 270□, and a vertical line thickness of 55□.

For the sake of convenience in experimentation, an electromagnetic wave shielding layer, having an electromagnetic wave shielding net formed of a cupper material having a pitch of 200□ and a line thickness of 20□, was attached to an outer part of the PDP panel, disposed at 41 with respect to a horizontal side of the panel. While varying the angle of disposition of the stripes of the film for improving contrast with respect to the horizontal lines of the panel, the moire phenomenon was observed. The results are shown in Table 3, in which ◯ denotes no moire observed, Δ denotes a mild degree of moire observed, and X denotes a severe degree of moire observed, potentially affecting the picture quality.

Table 3

TABLE 3

| angle(°) | 1.5 | 2.5 | 4 | 6 | 10 | 14 | 18 | 21 |
|---|---|---|---|---|---|---|---|---|
| moire | ◯ | ◯ | ◯ | Δ | Δ | Δ | X | X |

As shown in the results of Table 3, when the angle formed between the stripes of the film for improving contrast and the horizontal lines of the panel was 5° or less, moire was not observed at all, whereas when the angle was 5 to 14° a mild degree of moire was observed, and when the angle was more than 15°, a severe degree of moire was observed. Therefore, the stripes of the film for improving contrast may be disposed at an angle of 0 to 15° and particularly, at an angle of 0 to 5° with respect to the horizontal lines of the panel.

Formation of Ghost Image

The ghost image was examined in two cases: a case where the PDP display device was manufactured under the conditions of the inventive sample 1 (when the film for improving contrast was directly attached to the PDP filter); and a case where the conditions of the panel, the electromagnetic wave shielding net and the stripe angle are identical to the inventive sample 1 but the film for improving contrast was not directly attached to the PDP panel and attached to a glass substrate, in the form of goggles, at an outer side of the PDP display device with an air gap of about 3 mm maintained with the PDP panel.

As a result, when the film was directly attached, the image smudging did not occur as shown in FIG. 5(a), but when there was an air gap, the image smudged and the clarity of image was degraded as shown in FIG. 5(b).

Therefore, the present invention improves the contrast ratio while preventing moire and ghost image, thereby ensuring a high quality picture.

The present invention provides a film for improving contrast, capable of improving a contrast ratio without degrading a brightness of the light emitted from a PDP, and a PDP filter and a display device including the same. In addition, the PDP filter and the display device according to the present invention provide a high quality picture by preventing moire.

Furthermore, the PDP filter and the display device according to the present invention are capable of preventing a ghost image, thereby providing a clearer picture.

While the present invention has been shown and described in connection with the exemplary embodiments, it will be apparent to those skilled in the art that modifications and variations may be made without departing from the spirit and scope of the invention as defined by the appended claims.

1. A film for improving contrast, the film comprising a plurality of stripes each having a section in the shape of one of a trapezoid and a triangle, with a decreasing width from a surface of the film to an inner portion of the film, and a rectangle and a parallelogram, having a constant width from the surface of the film to the inner portion of the film, wherein, in a cross-sectional view cut along a thickness direction of the film, a line connecting an inner edge of an inner portion of one stripe with an inner edge of an outer portion of another adjacent stripe forms a shielding angle of 15 to 50° with a normal line perpendicular to a surface of the film.

2. The film of claim 1, wherein the shielding angle is 20 to 35°.

3. The film of claim 1, wherein the film is formed on a supporting body.

4. The film of claim 3, wherein the supporting body is formed of a transparent plastic film selected from a group consisting of a polyester resin film, an acrylic resin film, a cellulose resin film, a polyethylene resin film, a polypropylene resin film, a polyolefin resin film, a polyvinylchloride resin film, a polycarbonate resin film, a phenolic resin film, and a urethane resin film.

5. The film of claim 4, wherein the supporting body is formed of a polyester film.

6. The film of claim 1, wherein the film comprises at least one transparent film layer.

7. The film of claim 1, wherein the stripe has a pitch, which is a distance between a 14.4 center of a stripe to a center of another adjacent stripe, of 50 to 120K, and a depth of 70 to 200□.

8. The film of claim 1, wherein the stripe is formed of at least one selected from a group consisting of a black ink, a black dye, a black pigment and an inorganic material.

9. The film of claim 1, wherein an area ratio of the stripes to a surface area of the film is 50% or less.

10. The film of claim 1, wherein the stripes are formed in a material formed of at least one ultraviolet curable resin selected from a group consisting of urethane acrylate, epoxy acrylate, ester acrylate, ether acrylate and radical generating monomer.

11. A plasma display panel filter for improving contrast on which the film for improving contrast according to claim 1 is stacked, the filter comprising at least one of a transparent substrate, an anti-reflective layer and an electromagnetic wave shielding layer, wherein the stripes of the film for improving contrast are disposed at an angle of 0 to 15° with respect to a horizontal side of the filter.

12. The filter of claim 11, wherein the stripes are formed at an angle of 0 to 5° with respect to the horizontal side of the filter.

13. The filter of claim 11, wherein horizontal lines of an electromagnetic wave shielding net included in the electromagnetic wave shielding layer are formed at an angle of 35 to 55° with respect to the horizontal side of the filter.

14. The filter of claim 13, wherein a pitch, which is a distance between center lines of two adjacent ones of horizontal and vertical lines of the electromagnetic shielding net, is 100 to 500 μm.

15. The filter of claim 13, wherein each of the horizontal lines and vertical lines of the electromagnetic wave shielding net has a thickness of 5 to 35 μm.

16. The filter of claim 13, wherein the electromagnetic wave shielding net is formed of a material selected from a group consisting of Cu, Ag, Ni, Al, Cr, Fe and Ti.

17. The filter of claim 11, wherein the film for improving contrast is directly attached to the PDP filter.

18. A plasma display panel (PDP) device comprising a PDP panel and the filter of claim 11 attached to the PDP panel, wherein the stripes of the film for improving contrast included in the filter for improving contrast are formed at 0 to 15° with respect to horizontal lines forming a pixel region of the PDP panel, and horizontal lines of the electromagnetic wave shielding net included in the electromagnetic shielding layer are disposed to form an angle of 35 to 55 with respect to the horizontal lines forming the pixel region of the PDP panel.

19. The PDP device of claim 18, wherein the stripes are formed at an angle of 0 to 5° with respect to the horizontal lines forming the pixel region of the PDP panel.

20. The PDP device of claim 18, wherein a pitch, which is a distance between center lines of two adjacent ones of the horizontal lines and vertical lines of the electromagnetic shielding net, is 100 to 500μm.

21. (canceled)

22. (canceled)

23. (canceled)
